(19) United States
(12) Patent Application Publication
(10) Pub. No.: US 2024/0351334 A1
(43) Pub. Date: Oct. 24, 2024

(54) LIQUID EJECTION APPARATUS

(71) Applicant: SEIKO EPSON CORPORATION, Tokyo (JP)

(72) Inventor: Yuki SHIOHARA, MATSUMOTO-SHI (JP)

(21) Appl. No.: 18/636,412

(22) Filed: Apr. 16, 2024

(30) Foreign Application Priority Data
Apr. 19, 2023 (JP) 2023-068520

(51) Int. Cl. B41J 2/14

(52) U.S. Cl. CPC B41J 2/1433; B41J 2202/16

(57) ABSTRACT

A liquid ejection apparatus includes: a head configured to eject a liquid; a heat source; and a transfer member configured to transfer heat generated by the heat source to the head. The head includes a nozzle plate having a nozzle surface where a nozzle configured to eject a liquid opens, and a main body portion to which the nozzle plate is attached and which includes a supply flow path in communication with the nozzle. The transfer member surrounds the nozzle plate.

The present application is based on, and claims priority from JP Application Serial Number 2023-068520, filed Apr. 19, 2023, the disclosure of which is hereby incorporated by reference herein in its entirety.

### BACKGROUND

### 1. Technical Field

The present disclosure relates to a liquid ejection apparatus.

### 2. Related Art

JP-A-2013-136179 describes a liquid ejection apparatus including a head having a nozzle surface where a nozzle opens, a flow path that supplies a liquid to the head, and a heat source that heats the flow path. When the flow path is heated by the heat source, the liquid flowing through the flow path is heated. Accordingly, the head can normally eject the liquid from the nozzle.

JP-A-2013-136179 is an example of the related art.

In such a liquid ejection apparatus, since the nozzle surface is exposed to the outside air, a temperature of the nozzle surface is likely to decrease. When the temperature of the nozzle surface decreases, a temperature of the liquid located in the nozzle decreases. That is, even when the flow path is heated by the heat source, the temperature of the liquid located in the nozzle may decrease. When the temperature of the liquid located in the nozzle decreases, a size of ejected droplets may vary, which may affect the quality of an image to be recorded.

### SUMMARY

A liquid ejection apparatus that solves the above problems includes: a head configured to eject a liquid; a heat source; and a transfer member configured to transfer heat generated by the heat source to the head. The head includes a nozzle plate having a nozzle surface where a nozzle configured to eject a liquid opens, and a main body portion to which the nozzle plate is attached and which includes a supply flow path in communication with the nozzle. The transfer member surrounds the nozzle plate.

### BRIEF DESCRIPTION OF THE DRAWINGS

FIG. 1 is a cross-sectional view showing an example of a liquid ejection apparatus.

FIG. 2 is a bottom view of a recording unit.

FIG. 3 is a top view of the recording unit.

### DESCRIPTION OF EMBODIMENTS

Hereinafter, an example of a liquid ejection apparatus will be described with reference to the drawings. The liquid ejection apparatus is, for example, an inkjet printer that records images such as characters and photographs by ejecting ink, which is an example of a liquid, onto a medium such as paper or cloth.

### Liquid Ejection Apparatus

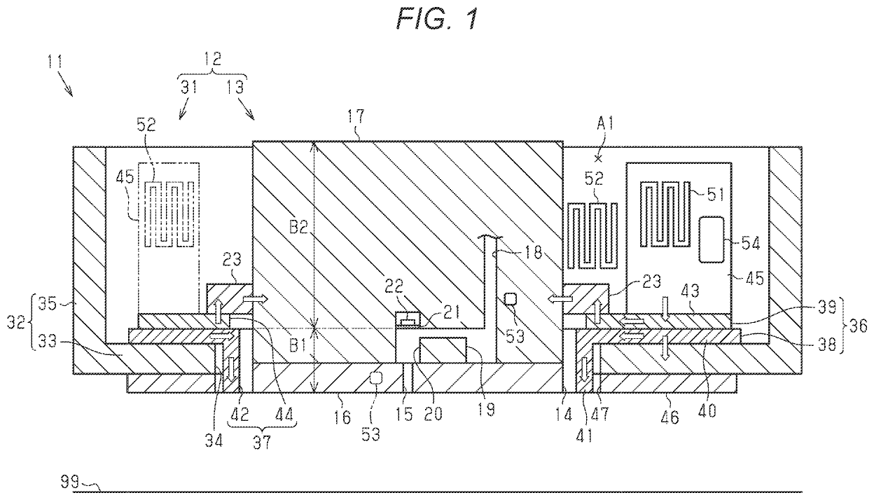

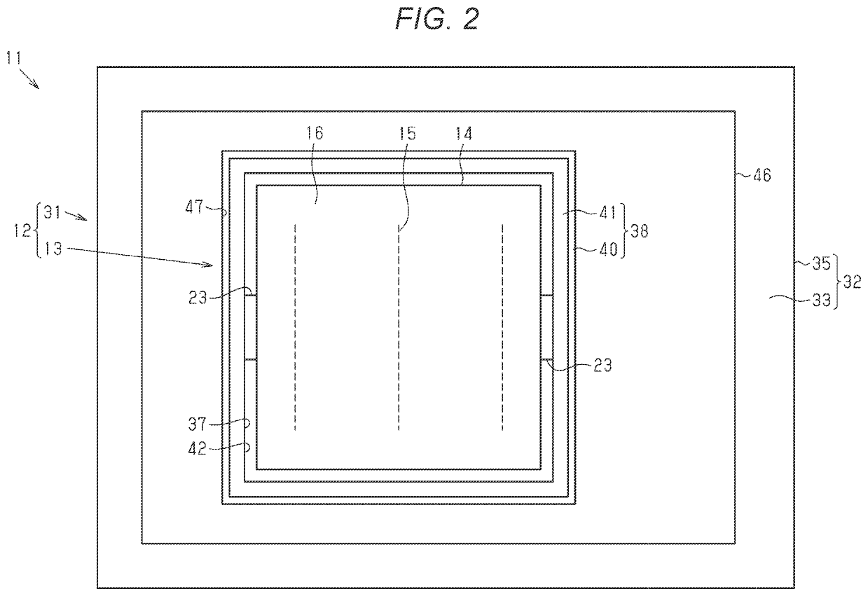

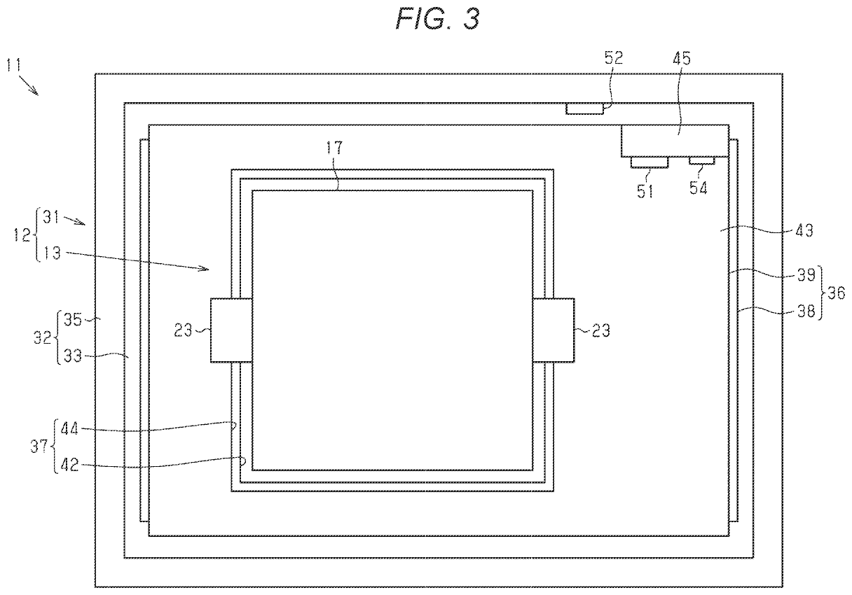

As shown in FIGS. 1, 2, and 3, a liquid ejection apparatus 11 includes a recording unit 12. The recording unit 12 is configured to record an image on a medium 99. Specifically, the recording unit 12 records an image on the medium 99 by ejecting a liquid onto the medium 99.

The recording unit 12 includes a head 13. The head 13 is configured to eject a liquid. The head 13 ejects a liquid onto the medium 99.

The head 13 includes a nozzle plate 14. The nozzle plate 14 is made of, for example, metal. The nozzle plate 14 has a nozzle surface 16 where one or more nozzles 15 open. The nozzle 15 penetrates through the nozzle plate 14. The head 13 ejects a liquid from the nozzle 15. The nozzle surface 16 is a surface facing the medium 99. Therefore, the nozzle surface 16 is exposed to the outside air. In the nozzle surface 16, one or more nozzle rows may be formed. The nozzle row is formed by arranging a plurality of nozzles 15 in one direction.

The head 13 includes a main body portion 17. The nozzle plate 14 is attached to the main body portion 17. In one example, the nozzle plate 14 is attached to a lower portion of the main body portion 17.

The main body portion 17 includes a supply flow path 18. The supply flow path 18 is a flow path extending through the main body portion 17. A liquid flows through the supply flow path 18. For example, a liquid is supplied to the supply flow path 18 from a reservoir attached to the liquid ejection apparatus 11. The reservoir is, for example, an ink cartridge. The supply flow path 18 communicates with the nozzle 15. A liquid is supplied from the supply flow path 18 to the nozzle 15.

The main body portion 17 includes a liquid chamber 19. The liquid chamber 19 is a space in communication with the supply flow path 18. A liquid is accommodated in the liquid chamber 19. The liquid chamber 19 communicates with one or more nozzles 15. Specifically, the liquid chamber 19 communicates with the plurality of nozzles 15 constituting one nozzle row.

The main body portion 17 includes a pressure chamber 20. The pressure chamber 20 is a space in communication with the liquid chamber 19. A liquid is accommodated in the pressure chamber 20. The pressure chamber 20 communicates with the nozzle 15. Therefore, the supply flow path 18 communicates with the nozzle 15 via the liquid chamber 19 and the pressure chamber 20.

The pressure chamber 20 communicates with one nozzle 15. Therefore, when the plurality of nozzles 15 open in the nozzle plate 14, the main body portion 17 includes the same number of pressure chambers 20 as the nozzles 15. When the liquid located in the pressure chamber 20 is pressurized, the liquid is ejected from the nozzle 15.

The main body portion 17 includes a diaphragm 21. The diaphragm 21 constitutes a part of a wall surface that defines the pressure chamber 20. The diaphragm 21 is configured to be bent. The diaphragm 21 is bent to change a volume of the pressure chamber 20. When the diaphragm 21 is bent, the liquid located in the pressure chamber 20 is pressurized. Accordingly, the liquid is ejected from the nozzle 15.

The main body portion 17 includes a piezoelectric element 22. The piezoelectric element 22 is attached to the diaphragm 21. Specifically, the piezoelectric element 22 is attached to an opposite surface among both surfaces of the diaphragm 21 from a surface facing the pressure chamber 20. When a voltage is applied to the piezoelectric element 22, the diaphragm 21 is bent. Accordingly, the liquid is ejected from the nozzle 15.

The head 13 includes one or more attachment portions 23. In one example, the head 13 includes two attachment portions 23. The attachment portion 23 is a portion attached to a carriage 31 to be described later. The attachment portion 23 extends from the main body portion 17. In one example, the attachment portion 23 protrudes laterally from a side surface of the main body portion 17. For example, when the head 13 is viewed from a direction perpendicular to the nozzle surface 16, the two attachment portions 23 are located symmetrically in the main body portion 17. Accordingly, a posture of the main body portion 17 is easily stabilized.

The head 13 includes a first region B1 and a second region B2. Each of the first region B1 and the second region B2 is a region obtained by dividing the head 13 into two in the direction perpendicular to the nozzle surface 16. The first region B1 is a portion of the head 13 in charge of ejecting a liquid. For example, the first region B1 includes the liquid chamber 19, the pressure chamber 20, and the nozzle 15. Therefore, the first region B1 includes the nozzle plate 14 and a part of the main body portion 17. The second region B2 is a region excluding the first region B1. For example, the second region B2 includes the supply flow path 18. Therefore, the second region B2 includes a part of the main body portion 17.

The recording unit 12 may include the carriage 31. The head 13 is mounted on the carriage 31. The carriage 31 scans the medium 99. Accordingly, the head 13 can eject the liquid across a width of the medium 99. That is, the liquid ejection apparatus 11 is a serial printer. The liquid ejection apparatus 11 may be a line printer in which the recording unit 12 can eject the liquid all at once across the width of the medium 99. When the liquid ejection apparatus 11 is a line printer, the carriage 31 does not scan the medium 99, and the head 13 is mounted on the carriage 31.

The carriage 31 includes a base member 32. The base member 32 is a member that supports the head 13. The base member 32 accommodates the head 13.

The base member 32 includes a support portion 33. The support portion 33 is a portion that supports the head 13. The support portion 33 receives a load of the head 13. In one example, the support portion 33 extends horizontally. For example, the support portion 33 has a rectangular shape or a rectangular-like shape when the recording unit 12 is viewed from the direction perpendicular to the nozzle surface 16.

An exposure opening 34 opens in the support portion 33. The exposure opening 34 is an opening that exposes the nozzle plate 14. The exposure opening 34 has a rectangular shape or a rectangular-like shape when the recording unit 12 is viewed from the direction perpendicular to the nozzle surface 16.

The base member 32 includes an accommodating portion 35. The accommodating portion 35 is a portion that accommodates the head 13. The accommodating portion 35 extends from the support portion 33. The accommodating portion 35 extends perpendicularly from an outer edge of the support portion 33, for example. In one example, the accommodating portion 35 extends vertically. Accordingly, the accommodating portion 35 surrounds the head 13. Specifically, the accommodating portion 35 surrounds the main body portion 17. The accommodating portion 35 defines an accommodating space A1 in which the head 13 is accommodated.

The carriage 31 includes a transfer member 36. The transfer member 36 is a member that transfers heat to the head 13. Specifically, the transfer member 36 is configured to transfer heat generated by a heat source to be described later to the head 13. That is, the transfer member 36 transfers heat to the head 13 by being heated by the heat source. The transfer member 36 heats the liquid located in the head 13 by transferring heat to the head 13. Therefore, the transfer member 36 may be made of a material having high thermal conductivity. The transfer member 36 is made of sheet metal, for example.

In the liquid ejection apparatus 11, a temperature of the liquid is important. This is because a viscosity of the liquid affects ejection accuracy of the liquid. That is, when a temperature of the liquid located in the head 13 is low, a viscosity of the liquid increases, and thus it becomes difficult to eject the liquid from the nozzle 15. Particularly, when the temperature of the liquid located in the nozzle 15 is low, the ejection accuracy of the liquid is greatly affected. In the head 13, since the nozzle surface 16 is exposed to the outside air, the temperature of the liquid located in the nozzle 15 is likely to decrease. Therefore, in the liquid ejection apparatus 11, it is required to heat the liquid located in the nozzle 15.

The transfer member 36 transfers heat to the nozzle plate 14. The transfer member 36 may transfer heat to the main body portion 17 in addition to the nozzle plate 14. The transfer member 36 is attached to the base member 32, for example. In one example, the transfer member 36 is attached to the support portion 33.

The transfer member 36 surrounds the nozzle plate 14. Specifically, a surrounding opening 37 opens in the transfer member 36. The head 13 is inserted into the surrounding opening 37. The nozzle plate 14 is located in the surrounding opening 37. In this way, the transfer member 36 surrounds the nozzle plate 14. Accordingly, the transfer member 36 transfers heat to the nozzle plate 14. As a result, the liquid located in the nozzle 15 is heated.

The transfer member 36 may surround the main body portion 17 in addition to the nozzle plate 14. That is, in addition to the nozzle plate 14, the main body portion 17 may be located in the surrounding opening 37. Accordingly, the transfer member 36 transfers heat not only to the nozzle plate 14 but also to the main body portion 17. As a result, the liquid located in the supply flow path 18 is heated. When the heat is transferred to the main body portion 17, the liquid located in the liquid chamber 19 and the pressure chamber 20 is heated. Accordingly, the liquid can be effectively heated while the liquid moves to the nozzle 15.

The transfer member 36 surrounds the nozzle plate 14 without being in contact with the nozzle plate 14. That is, the nozzle plate 14 is not in contact with an edge of the transfer member 36 that defines the surrounding opening 37. When the transfer member 36 is not in contact with the nozzle plate 14, the heat is transferred from the transfer member 36 to the nozzle plate 14 mainly by convection of air located between the transfer member 36 and the nozzle plate 14, radiation of the transfer member 36, and the like. When the transfer member 36 is in contact with the nozzle plate 14, the heat is transferred from the transfer member 36 to the nozzle plate 14 mainly by heat conduction. When the heat is transferred to the nozzle plate 14 by the heat conduction, a temperature at a contact portion between the transfer member 36 and the nozzle plate 14 increases, which may increase a thermal gradient of the nozzle plate 14.

The transfer member 36 may or may not be in contact with the main body portion 17. When the transfer member 36 is in contact with the main body portion 17, a thermal gradient of the main body portion 17 increases. Therefore, a thermal gradient of the liquid located in the supply flow path 18 is likely to increase. However, since the thermal gradient of the liquid is reduced during a process in which the liquid flows from the main body portion 17 to the nozzle plate 14, there is no problem even when the main body portion 17 is in contact with, for example, the edge of the transfer member 36 that defines the surrounding opening 37.

The transfer member 36 may hold the head 13. For example, the transfer member 36 may hold the head 13 by being in contact with the attachment portion 23. Accordingly, the heat is easily transferred from the transfer member 36 to the main body portion 17 via the attachment portion 23. Instead of the transfer member 36, the base member 32 may directly hold the head 13. Since the transfer member 36 serves to transfer heat and hold the head 13, it is not necessary to provide a new holding member. Therefore, the configuration can be simplified, and the apparatus can be downsized.

The transfer member 36 includes one or more members. In one example, the transfer member 36 includes a first member 38 and a second member 39. The first member 38 and the second member 39 are each made of sheet metal, for example. The first member 38 and the second member 39 may be integrally formed.

The first member 38 is a member surrounding the nozzle plate 14. That is, the first member 38 surrounds the nozzle 15. The first member 38 may surround the main body portion 17 in addition to the nozzle plate 14. For example, the first member 38 may surround the supply flow path 18 in addition to the nozzle 15. The first member 38 may surround the liquid chamber 19, the pressure chamber 20, and the like. In one example, the first member 38 surrounds the first region B1 of the head 13.

The first member 38 includes a receiving portion 40. The receiving portion 40 is a portion that receives the heat generated by the heat source from the second member 39. The receiving portion 40 is attached to the base member 32, for example. In one example, the receiving portion 40 is attached to the support portion 33. The receiving portion 40 extends along the support portion 33. In one example, the receiving portion 40 extends to be exposed from the exposure opening 34 when the recording unit 12 is viewed from the direction perpendicular to the nozzle surface 16.

The first member 38 includes a surrounding portion 41. The surrounding portion 41 is a portion that surrounds the nozzle plate 14. The surrounding portion 41 defines a first opening 42. The first opening 42 constitutes the surrounding opening 37. The nozzle plate 14 is located in the first opening 42. The nozzle plate 14 is exposed through the first opening 42. In one example, the surrounding portion 41 also surrounds the main body portion 17 in addition to the nozzle plate 14.

The surrounding portion 41 extends from the receiving portion 40. Specifically, the surrounding portion 41 extends from an inner edge of the receiving portion 40 toward the exposure opening 34. The surrounding portion 41 extends to pass through the exposure opening 34. In one example, a tip end of the surrounding portion 41 is located at a height the same as that of the nozzle surface 16. The tip end of the surrounding portion 41 may be located below the nozzle surface 16 or above the nozzle surface 16. The surrounding portion 41 can surround the nozzle plate 14 by being located at least on a side of the nozzle plate 14. Since the surrounding portion 41 surrounds the nozzle plate 14, heat received by the receiving portion 40 is transferred to the nozzle plate 14 via the surrounding portion 41.

The surrounding portion 41 surrounds the nozzle plate 14 without being in contact with the nozzle plate 14. Therefore, there is a gap between the surrounding portion 41 and the nozzle plate 14. When the surrounding portion 41 is in contact with the nozzle plate 14, the thermal gradient of the nozzle plate 14 may increase. Since the surrounding portion 41 is not in contact with the nozzle plate 14, the nozzle plate 14 is uniformly heated.

The second member 39 is a member that surrounds the main body portion 17. That is, the second member 39 surrounds the supply flow path 18. The second member 39 may surround the nozzle plate 14 in addition to the main body portion 17. For example, the second member 39 may surround the nozzle 15 in addition to the supply flow path 18. The second member 39 may surround the liquid chamber 19, the pressure chamber 20, and the like. In one example, the second member 39 surrounds a part of the second region B2 of the head 13.

The second member 39 includes a contact portion 43. The contact portion 43 is a portion that is in contact with the first member 38. Specifically, the contact portion 43 is in contact with the receiving portion 40. Accordingly, the contact portion 43 transfers heat to the receiving portion 40. The contact portion 43 is attached to the receiving portion 40. The contact portion 43 extends along the receiving portion 40. The contact portion 43 is located on the receiving portion 40.

The contact portion 43 surrounds the main body portion 17. The contact portion 43 defines a second opening 44. The second opening 44 constitutes the surrounding opening 37. The second opening 44 communicates with the first opening 42. The main body portion 17 is located in the second opening 44. The nozzle plate 14 is exposed through the second opening 44.

The contact portion 43 surrounds the main body portion 17 without being in contact with the main body portion 17. Specifically, the contact portion 43 surrounds the main body portion 17 without being in contact with a side surface of the main body portion 17. Therefore, the heat is transferred from the contact portion 43 to the main body portion 17 due to convection of air located between the contact portion 43 and the main body portion 17, radiation of the contact portion 43, and the like.

The contact portion 43 may surround the main body portion 17 in a state of being in contact with the main body portion 17. That is, the contact portion 43 may be in contact with the side surface of the main body portion 17. This is because there is no problem even when the thermal gradient of the main body portion 17 increases as described above. The second member 39 is not in contact with the nozzle plate 14. As described above, this is also because the thermal gradient of the nozzle plate 14 may increase.

The contact portion 43 holds the head 13. The contact portion 43 is in contact with the attachment portion 23. The contact portion 43 supports the attachment portion 23 from below, for example. The attachment portion 23 is attached to the contact portion 43. Therefore, the second member 39 transfers heat from the contact portion 43 to the attachment portion 23. That is, the second member 39 transfers heat from the contact portion 43 to the main body portion 17 by the heat conduction through the attachment portion 23. Therefore, while the first member 38 is not in contact with the head 13, the second member 39 is in contact with the head 13.

The second member 39 may include a fixed portion 45. The fixed portion 45 is a portion to which the heat source is fixed. The fixed portion 45 extends from the contact portion 43. For example, the fixed portion 45 extends vertically from an outer edge of the contact portion 43. In one example, the fixed portion 45 is located at a location laterally shifted from the head 13 when the recording unit 12 is viewed from the front. In this case, since a distance between the nozzle plate 14 and the heat source is biased, the thermal gradient of the nozzle plate 14 may increase. Therefore, it is important that the transfer member 36 is not in contact with the nozzle plate 14.

The second member 39 may include two fixed portions 45. For example, the second member 39 may include two fixed portions 45 located symmetrically with respect to the recording unit 12 as indicated by a two-dot chain line in FIG. 1. When the recording unit 12 is viewed from the front, the second member 39 may include the fixed portion 45 located at a location shifted to one side from the recording unit 12 and the fixed portion 45 located at a location shifted to the other side from the recording unit 12. In this case, the heat source is fixed to each of the two fixed portions 45. This reduces an increase in thermal gradient of the nozzle plate 14.

The carriage 31 may include an air-regulating plate 46. The air-regulating plate 46 is attached to the base member 32. Specifically, the air-regulating plate 46 is attached to the support portion 33. The air-regulating plate 46 is located between the support portion 33 and the medium 99.

The air-regulating plate 46 is a plate that regulates a flow of air flowing between the carriage 31 and the medium 99 when the carriage 31 moves. The air-regulating plate 46 reduces occurrence of turbulence between the carriage 31 and the medium 99. As a result, the recording quality is improved.

A continuous opening 47 opens in the air-regulating plate 46. The continuous opening 47 is an opening for exposing the head 13. Specifically, the continuous opening 47 exposes the nozzle plate 14. The continuous opening 47 communicates with the exposure opening 34. In one example, the nozzle plate 14 and the surrounding portion 41 are located in the continuous opening 47.

The liquid ejection apparatus 11 includes one or more heat sources. In one example, the liquid ejection apparatus 11 includes a first heat source 51 and a second heat source 52. The liquid ejection apparatus 11 may include only the first heat source 51 or only the second heat source 52. The heat source is attached to the carriage 31. The heat source is, for example, a heating wire. The heat source generates heat when a current flows. The heat generated by the heat source is transferred to the head 13 by the transfer member 36. Accordingly, even when the heat source is not attached to the main body portion 17 but is attached to the carriage 31, the head 13 can be effectively heated by the transfer member 36.

The first heat source 51 is attached to the transfer member 36. In one example, the first heat source 51 is attached to the second member 39. Specifically, the first heat source 51 is attached to the fixed portion 45. The first heat source 51 is not in contact with the first member 38. Therefore, the heat from the first heat source 51 is transferred to the fixed portion 45, the contact portion 43, the receiving portion 40, and the surrounding portion 41 in this order. White arrows shown in FIG. 1 represent heat transfer by the first heat source 51.

The second heat source 52 is attached to the base member 32. In one example, the second heat source 52 is attached to the accommodating portion 35. The second heat source 52 mainly heats the accommodating space A1. This reduces a decrease in temperature of the head 13. As the second heat source 52 heats the accommodating space A1, the transfer member 36 is heated. Therefore, the heat from the second heat source 52 is transferred to the head 13 by the transfer member 36.

Similar to the first heat source 51, the second heat source 52 may be attached to the fixed portion 45. For example, when the second member 39 includes two fixed portions 45, the second heat source 52 may be attached to the fixed portion 45 different from the fixed portion 45 to which the first heat source 51 is attached among the two fixed portions 45, as indicated by a two-dot chain line in FIG. 1. The liquid ejection apparatus 11 may include a third heat source attached to the fixed portion 45 different from the fixed portion 45 to which the first heat source 51 is attached among the two fixed portions 45. This can reduce an increase in thermal gradient of the nozzle plate 14.

The liquid ejection apparatus 11 may include one or more detection units. In one example, the liquid ejection apparatus 11 includes a first detection unit 53 and a second detection unit 54. The liquid ejection apparatus 11 may include only the first detection unit 53 without including the second detection unit 54. The detection unit is configured to detect a temperature. The detection unit detects a temperature of a liquid or a temperature of the head 13, for example. The detection unit is, for example, a thermistor. The liquid ejection apparatus 11 controls the heat source based on the temperature detected by the detection unit. That is, the liquid ejection apparatus 11 checks whether the liquid is maintained at an appropriate temperature by the heat source. For example, when the temperature of the liquid is low, the liquid ejection apparatus 11 increases output of the heat source.

The first detection unit 53 is attached to the head 13. In one example, the first detection unit 53 is attached to the main body portion 17. The first detection unit 53 is incorporated in the main body portion 17, for example. The first detection unit 53 is located in the vicinity of the supply flow path 18 in the main body portion 17.

The first detection unit 53 detects a temperature of the liquid located in the head 13. In one example, the first detection unit 53 detects a temperature of the main body portion 17. Specifically, the first detection unit 53 detects a temperature of the liquid flowing through the supply flow path 18.

The liquid ejection apparatus 11 can estimate the temperature of the liquid located in the nozzle 15 from the temperature of the liquid located in the supply flow path 18. For example, the liquid ejection apparatus 11 estimates the temperature of the liquid located in the nozzle 15 from the temperature of the liquid located in the supply flow path 18 based on data indicating a temperature decrease degree of the liquid flowing from the supply flow path 18 to the nozzle 15. The liquid ejection apparatus 11 may control the heat source based on the estimated temperature of the liquid located in the nozzle 15. That is, the liquid ejection apparatus 11 may control the heat source based on the temperature detected by the first detection unit 53 such that the liquid located in the nozzle 15 has an appropriate temperature.

The first detection unit 53 is not limited to being attached to the main body portion 17, and may be attached to the nozzle plate 14 as indicated by a two-dot chain line in FIG. 1, for example. In this case, the first detection unit 53 detects a temperature of the nozzle plate 14. Specifically, the first detection unit 53 detects the temperature of the liquid located in the nozzle 15. In this case, the liquid ejection apparatus 11 may control the heat source such that the temperature detected by the first detection unit 53 is an appropriate temperature.

The second detection unit 54 detects temperature of the transfer member 36. In one example, the second detection unit 54 detects the temperature of the second member 39. Specifically, the second detection unit 54 detects a temperature of the fixed portion 45. The second detection unit 54 is attached to the transfer member 36. Specifically, the second detection unit 54 is attached to the fixed portion 45. That is, the second detection unit 54 detects a temperature of the first heat source 51.

The liquid ejection apparatus 11 can check a heat transfer degree based on the temperature detected by the first detection unit 53 and the temperature detected by the second detection unit 54. For example, when a difference between the temperature detected by the first detection unit 53 and the temperature detected by the second detection unit 54 is small, it is possible to grasp that the heat can be effectively transferred from the heat source to the head 13 by the transfer member 36. The liquid ejection apparatus 11 may control the heat source based on the temperature detected by the first detection unit 53 and the temperature detected by the second detection unit 54. Accordingly, the liquid ejection apparatus 11 can finely control the heat source as compared with the case where only the first detection unit 53 is provided.

### Operation and Effect

Next, an operation and an effect of the above-described example will be described.

(1) The transfer member 36 surrounds the nozzle plate 14. According to the above configuration, the heat generated by the heat source is transferred to the nozzle plate 14 through the transfer member 36. Accordingly, the liquid located in the nozzle 15 is heated. Therefore, a decrease in temperature of the liquid located in the nozzle 15 is reduced.

(2) The transfer member 36 surrounds the nozzle plate 14 and the main body portion 17. According to the above configuration, in addition to the liquid located in the nozzle 15, the liquid located in the supply flow path 18 is heated. Therefore, a decrease in temperature of the liquid located in the nozzle 15 can be further reduced.

(3) The transfer member 36 includes the first member 38 that surrounds the nozzle plate 14 and the second member 39 that surrounds the main body portion 17. The first heat source 51 is attached to the second member 39. The first member 38 is in contact with the second member 39. According to the above configuration, the heat from the first heat source 51 is transferred to the first member 38 through the second member 39. Therefore, compared to the case where the heat from the first heat source 51 is directly transferred to the first member 38, excessive heating of the first member 38 can be reduced. This reduces excessive heating of the liquid located in the nozzle 15.

(4) The first member 38 is not in contact with the head 13, and the second member 39 is in contact with the head 13. According to the above configuration, compared to the case where the first member 38 is in contact with the head 13, excessive heating of the liquid located in the nozzle 15 can be reduced.

(5) The heat source is attached to the carriage 31. According to the above configuration, the head 13 can be effectively heated by the heat from the heat source. This reduces a decrease in temperature of the liquid located in the head 13.

(6) The first detection unit 53 is attached to the nozzle plate 14 and detects the temperature of the liquid located in the nozzle 15. According to the above configuration, it is possible to grasp whether the temperature of the liquid located in the nozzle 15 decreases.

(7) The first detection unit 53 is attached to the main body portion 17 and detects the temperature of the liquid located in the supply flow path 18. According to the above configuration, it is possible to grasp whether the temperature of the liquid located in the supply flow path 18 decreases.

(8) The transfer member 36 holds the head 13. According to the above configuration, the heat generated by the heat source is easily transferred to the head 13 through the transfer member 36. This reduces a decrease in temperature of the liquid located in the head 13.

### Modification

The above example can be modified as follows. The above-described example and the following modifications can be combined with each other without technical contradiction.

The transfer member 36 may be in contact with the nozzle plate 14. In this case, it is preferable that the transfer member 36 is in contact with an entire periphery of the nozzle plate 14 in order to reduce the thermal gradient of the nozzle plate 14. It is preferable that the heat source is disposed such that the transfer member 36 is uniformly heated.

The liquid ejected by the head 13 is not limited to ink, and may be, for example, a liquid material obtained by dispersing or mixing functional material particles in a liquid. For example, the head 13 may eject a liquid material containing, in a dispersed or dissolved form, a material such as an electrode material or a painting material used in manufacture of a liquid crystal display, an electroluminescent display, and a surface emitting display.

### Technology

In the following description, technical ideas understood from the example and the modification described above and the operational effect thereof will be described.

(A) A liquid ejection apparatus includes: a head configured to eject a liquid; a heat source; and a transfer member configured to transfer heat generated by the heat source to the head. The head includes a nozzle plate having a nozzle surface where a nozzle configured to eject a liquid opens, and a main body portion to which the nozzle plate is attached and which includes a supply flow path in communication with the nozzle. The transfer member surrounds the nozzle plate.

According to the above configuration, the heat generated by the heat source is transferred to the nozzle plate through the transfer member. Accordingly, the liquid located in the nozzle is heated. Therefore, a decrease in temperature of the liquid located in the nozzle can be reduced.

(B) In the liquid ejection apparatus, the transfer member may surround the nozzle plate and the main body portion.

According to the above configuration, in addition to the liquid located in the nozzle, the liquid located in the supply flow path is heated. Therefore, a decrease in temperature of the liquid located in the nozzle can be further reduced.

(C) In the liquid ejection apparatus, the transfer member may include a first member configured to surround the nozzle plate, and a second member configured to surround the main body portion, the heat source is attached to the second member, and the first member is in contact with the second member.

According to the above configuration, the heat generated by the heat source is transferred to the first member through the second member. Therefore, compared to the case where the heat generated by the heat source is directly transferred to the first member, excessive heating of the first member can be reduced. This reduces excessive heating of the liquid located in the nozzle.

(D) In the liquid ejection apparatus, the first member may be not in contact with the head, and the second member may be in contact with the head.

According to the above configuration, compared to the case where the first member is in contact with the head, excessive heating of the liquid located in the nozzle can be reduced.

(E) The liquid ejection apparatus may include a carriage on which the head is mounted, and the heat source may be attached to the carriage.

According to the above configuration, the head can be effectively heated by the heat from the heat source. This reduces a decrease in temperature of the liquid located in the head.

(F) The liquid ejection apparatus may include a detection unit configured to detect a temperature of a liquid, and the detection unit may be attached to the nozzle plate and detect a temperature of a liquid located in the nozzle.

According to the above configuration, it is possible to grasp whether the temperature of the liquid located in the nozzle decreases.

(G) The liquid ejection apparatus may include a detection unit configured to detect a temperature of a liquid, and the detection unit may be attached to the main body portion and detect a temperature of a liquid located in the supply flow path.

According to the above configuration, it is possible to grasp whether the temperature of the liquid positioned in the supply flow path decreases.

(H) In the liquid ejection apparatus, the transfer member may hold the head.

According to the above configuration, the heat generated by the heat source is easily transferred to the head through the transfer member. This reduces a decrease in temperature of the liquid located in the head.

What is claimed is:

1. A liquid ejection apparatus comprising:
a head configured to eject a liquid;
a heat source; and
a transfer member configured to transfer heat generated by the heat source to the head, wherein
the head includes
a nozzle plate having a nozzle surface where a nozzle configured to eject a liquid opens, and
a main body portion to which the nozzle plate is attached and which includes a supply flow path in communication with the nozzle, and
the transfer member surrounds the nozzle plate.

2. The liquid ejection apparatus according to claim 1, wherein
the transfer member surrounds the nozzle plate and the main body portion.

3. The liquid ejection apparatus according to claim 2, wherein
the transfer member includes
a first member configured to surround the nozzle plate, and
a second member configured to surround the main body portion,
the heat source is attached to the second member, and
the first member is in contact with the second member.

4. The liquid ejection apparatus according to claim 3, wherein
the first member is not in contact with the head, and
the second member is in contact with the head.

5. The liquid ejection apparatus according to claim 1, further comprising:
a carriage on which the head is mounted, wherein
the heat source is attached to the carriage.

6. The liquid ejection apparatus according to claim 1, further comprising:
a detection unit configured to detect a temperature of a liquid, wherein
the detection unit is attached to the nozzle plate and detects a temperature of a liquid located in the nozzle.

7. The liquid ejection apparatus according to claim 1, further comprising:
a detection unit configured to detect a temperature of a liquid, wherein
the detection unit is attached to the main body portion and detects a temperature of a liquid located in the supply flow path.

8. The liquid ejection apparatus according to claim 1, wherein
the transfer member holds the head.

9. The liquid ejection apparatus according to claim 5, wherein
the transfer member holds the head.
